(19) United States
(12) Patent Application Publication
(10) Pub. No.: US 2022/0190367 A1
(43) Pub. Date: Jun. 16, 2022

(54) FUEL CELL POWER GENERATION SYSTEM

(71) Applicant: Mitsubishi Power, Ltd., Kanagawa (JP)

(72) Inventors: Norihisa MATAKE, Tokyo (JP); Yasushi IWAI, Tokyo (JP); Ryutaro MORI, Tokyo (JP); Takahiro JOJIMA, Tokyo (JP); Daigo KOBAYASHI, Yokohama-shi, Kanagawa (JP)

(21) Appl. No.: 17/432,239

(22) PCT Filed: Nov. 21, 2019
(86) PCT No.: PCT/JP2019/045527

§ 371 Date: Aug. 19, 2021

(30) Foreign Application Priority Data
Feb. 27, 2019 (JP) 2019-033435

(51) Int. Cl. H01M 8/0432; H01M 8/04089

(52) U.S. Cl. CPC H01M 8/04365; H01M 8/04291; H01M 8/04097

(57) ABSTRACT

A fuel cell power generation system includes a first fuel cell and a second fuel cell generating power using a second fuel gas exhausted from the first fuel cell. A regulating valve is used for regulating a supply amount of an oxidant gas to be supplied to the second fuel cell in such a manner that a temperature at the second fuel cell becomes a reference value.

### TECHNICAL FIELD

The present disclosure relates to a fuel cell power generation system generating power using a plurality of fuel cells.

### BACKGROUND

A solid oxide fuel cell (SOFC) is known as one of power generation devices. The solid oxide fuel cell has conventionally been used as a combined cycle power generation system by being combined with another power generation device such as a gas turbine or a steam turbine. In the combined cycle power generation system, a fuel gas and an oxidant gas (air gas) are supplied to the solid oxide fuel cell in a preceding stage to generate power. In conjunction with this, an exit fuel gas (exhaust fuel gas) and an exit oxidant gas (exhaust air gas) exhausted from the solid oxide fuel cell are mixed with each other, cause combustion at a combustor, and are introduced into the gas turbine or the steam turbine in a subsequent stage, thereby causing a power generator coupled to such turbines to generate power. The energy of an exhaust gas exhausted from the turbine is collected further by an exhaust collection system.

In such a combined cycle power generation system, the efficiency of the gas turbine or the steam turbine is lower than that of the solid oxide fuel cell. In response to this, Patent Document 1 suggests a high-efficiency power generation system with a cascade connection of a plurality of solid oxide fuel cells formed by providing a solid oxide fuel cell further in a subsequent stage instead of a gas turbine or a steam turbine.

### CITATION LIST

### Patent Literature

### Patent Document 1: JP3924243

### SUMMARY

### Technical Problem

In a system with a cascade connection of a plurality of solid oxide fuel cells such as the one shown in Patent Document 1, a fuel gas having been used at a solid oxide fuel cell in a preceding stage is used at a solid oxide fuel cell in a subsequent stage. This reduces the concentration of the fuel gas used at the solid oxide fuel cell in the subsequent stage, compared to a concentration during use of the solid oxide fuel cell in the preceding stage. As a result, in the solid oxide fuel cell in the subsequent stage, output is suppressed to reduce a heat value resulting from power generation as compared with the solid oxide fuel cell in the preceding stage. This may cause difficulty in maintaining a temperature for operating the solid oxide fuel cell properly. In this case, a power generation voltage is reduced at the solid oxide fuel cell in the subsequent stage, causing a risk of reduction in system efficiency occurring particularly during partial-load operation.

At least one embodiment of the present invention has been made in view of the foregoing circumstances, and is intended to provide a fuel cell power generation system with a cascade connection of a plurality of solid oxide fuel cells capable of suppressing reduction in power generation performance and realizing excellent system efficiency by maintaining a temperature at a solid oxide fuel cell in a subsequent stage properly.

### Solution to Problem

(1) In order to solve the foregoing problem, a fuel cell power generation system according to at least one embodiment of the present invention includes:

a first fuel cell generating power using a first fuel gas and a first oxidant gas;

a second fuel cell generating power using a second fuel gas exhausted from the first fuel cell and a second oxidant gas supplied from at least one of an oxidant gas supply source and the first fuel cell; and

a regulating valve configured to regulate a supply amount of the second oxidant gas to be supplied to the second fuel cell,

the regulating valve being regulated in such a manner that a temperature at the second fuel cell becomes a reference value.

According to the foregoing configuration (1), the second oxidant gas supplied to the second fuel cell in a subsequent stage to the first fuel cell is configured to be capable of being regulated using the regulating valve. The regulation using the regulating valve is regulated in such a manner that a temperature at the second fuel cell becomes the reference value. This allows a temperature at a solid electrolyte in a subsequent stage to be maintained properly, making it possible to realize a high-efficiency fuel cell power generation system.

The first oxidant gas is air, for example. The second oxidant gas is air or gas of a lower oxygen concentration than air, for example.

(2) According to some embodiments, in the foregoing configuration (1),

the first oxidant gas and the second oxidant gas are supplied to the first fuel cell and the second fuel cell through a first oxidant gas supply line and a second oxidant gas supply line respectively arranged parallel to each other relative to the oxidant gas supply source common to the first oxidant gas and the second oxidant gas, and

the regulating valve is arranged in at least one of the first oxidant gas supply line and the second oxidant gas supply line.

According to the foregoing configuration (2), the first fuel cell and the second fuel cell are connected parallel to each other relative to the oxidant gas supply source through the first oxidant gas supply line and the second oxidant gas supply line. Providing the regulating valve in at least one of the first oxidant gas supply line and the second oxidant gas supply line in this way allows regulation of a supply ratio between the oxidant gases to be supplied to the first fuel cell and the second fuel cell. By doing so, a configuration for regulating a supply amount of the oxidant gas to be supplied to a solid oxide fuel cell in the subsequent stage can be realized in an efficient layout.

(3) According to some embodiments, the foregoing configuration (1) includes:

a third oxidant gas supply line arranged between the first fuel cell and the second fuel cell in such a manner that the first oxidant gas is supplied as the second oxidant gas to the second fuel cell after being exhausted from the first fuel cell; and

a fourth oxidant gas supply line branching from the third oxidant gas supply line in such a manner as to bypass the second fuel cell, wherein

the regulating valve is arranged in at least one of the third oxidant gas supply line and the fourth oxidant gas supply line.

According to the foregoing configuration (3), the oxidant gas having been used at the first fuel cell is fed through the third oxidant gas supply line to the second fuel cell in the subsequent stage and used at the second fuel cell. Even in such a case where a supply path for the oxidant gas is provided serially over the first fuel cell and the second fuel cell, providing the fourth oxidant supply line branching from the third oxidant supply line in such a manner as to bypass the second fuel cell and arranging the regulating valve in at least one of the third oxidant supply line and the fourth oxidant supply line still makes it possible to regulate a supply ratio between the oxidant gases to be supplied to the first fuel cell and the second fuel cell. By doing so, a configuration for regulating a supply amount of the oxidant gas to be supplied to the solid oxide fuel cell in the subsequent stage can be realized in an efficient layout.

(4) According to some embodiments, any one of the foregoing configurations (1) to (3) includes:

a combustor causing combustion of a third fuel gas exhausted from the second fuel cell;

a turbine arranged downstream from the combustor; and

a compressor driven by the turbine, wherein

the second oxidant gas is supplied to the turbine without intervention of the combustor after being exhausted from the second fuel cell.

According to the foregoing configuration (4), the oxidant gas exhausted from the second fuel cell is supplied directly to a turbocharger without intervention of the combustor. This makes it possible to avoid increase in pressure loss occurring in the presence of intervention of the combustor, thereby allowing suppression of collecting power reduction at the turbocharger.

(5) According to some embodiments, in the foregoing configuration (4),

the first oxidant gas is supplied to the combustor after being exhausted from the first fuel cell.

According to the foregoing configuration (5), the oxidant gas exhausted from the first fuel cell is supplied to the combustor without being supplied to the second fuel cell. This exhausted gas is mixed with the third fuel gas exhausted from the second fuel cell to cause combustion at the combustor, thereby allowing the turbocharger to be driven efficiently.

(6) According to some embodiments, any one of the foregoing configurations (1) to (3) includes:

a combustor causing combustion of a third fuel gas exhausted from the second fuel cell;

a turbine arranged downstream from the combustor; and

the compressor driven by the turbine, wherein

the first oxidant gas and the second oxidant gas are supplied to the combustor after being exhausted from the first fuel cell and the second fuel cell respectively.

According to the foregoing configuration (6), the oxidant gases exhausted from corresponding ones of the first fuel cell and the second fuel cell are supplied to the combustor. These oxidant gases are mixed with the third fuel gas exhausted from the second fuel cell to cause combustion at the combustor, thereby allowing the turbocharger to be driven efficiently.

(7) According to some embodiments, any one of the foregoing configurations (1) to (6) further includes:

a pressure vessel housing the first fuel cell and the second fuel cell, wherein

the regulating valve is arranged outside the pressure vessel.

According to the foregoing configuration (7), arranging the regulating valve outside the pressure vessel facilitates access to the regulating valve. This facilitates manual operation on the regulating valve by an operator for regulating a supply amount of the oxidant gas to be supplied to the second fuel cell, for example.

(8) According to some embodiments, any one of the foregoing configurations (1) to (7) includes:

a moisture collector collecting moisture in the second fuel gas; and

a recirculation line causing part of the second fuel gas to recirculate into the first fuel cell after the moisture is collected by the moisture collector.

According to the foregoing configuration (8), moisture in the second fuel gas to be supplied to the second fuel cell is collected by the moisture collector before the second fuel gas is supplied to the second fuel cell. Part of the second fuel gas is caused to recirculate through the recirculation line into the first fuel cell after the moisture is collected. This makes it possible to increase a heat value of the second fuel gas supplied to the second fuel cell, thereby allowing suppression of reduction in output from the second fuel cell.

(9) According to some embodiments, any one of the foregoing configurations (1) to (8) includes:

at least one fuel cell unit in which the second fuel cell is arranged between a plurality of the first fuel cells.

According to the foregoing configuration (9), arranging the second fuel cell to handle the fuel gas of a low heat value between the first fuel cells makes it possible to suppress temperature drop at the second fuel cell more effectively and to realize excellent system efficiency.

### Advantageous Effects

According to at least one aspect of the present invention, it is possible to provide a fuel cell power generation system with a cascade connection of a plurality of solid oxide fuel cells capable of suppressing reduction in power generation performance and realizing excellent system efficiency by maintaining a temperature at a solid oxide fuel cell in a subsequent stage properly.

### BRIEF DESCRIPTION OF DRAWINGS

FIG. 1 is a schematic view showing an entire configuration of a fuel cell power generation system according to a first embodiment.

FIG. 2 is a schematic view showing an entire configuration of a fuel cell power generation system according to a second embodiment.

FIG. 3 is a schematic view showing an entire configuration of a fuel cell power generation system according to a third embodiment.

FIG. 4 is a schematic view showing an entire configuration of a fuel cell power generation system according to a fourth embodiment.

FIG. 5 is a modification of FIG. 4.

### DETAILED DESCRIPTION

Some embodiments of the present invention will now be described in detail with reference to the accompanying drawings. It is intended, however, that unless particularly specified, dimensions, materials, shapes, relative positions and the like of components described in the embodiments shall be interpreted as illustrative only and not limitative of the scope of the present invention.

### First Embodiment

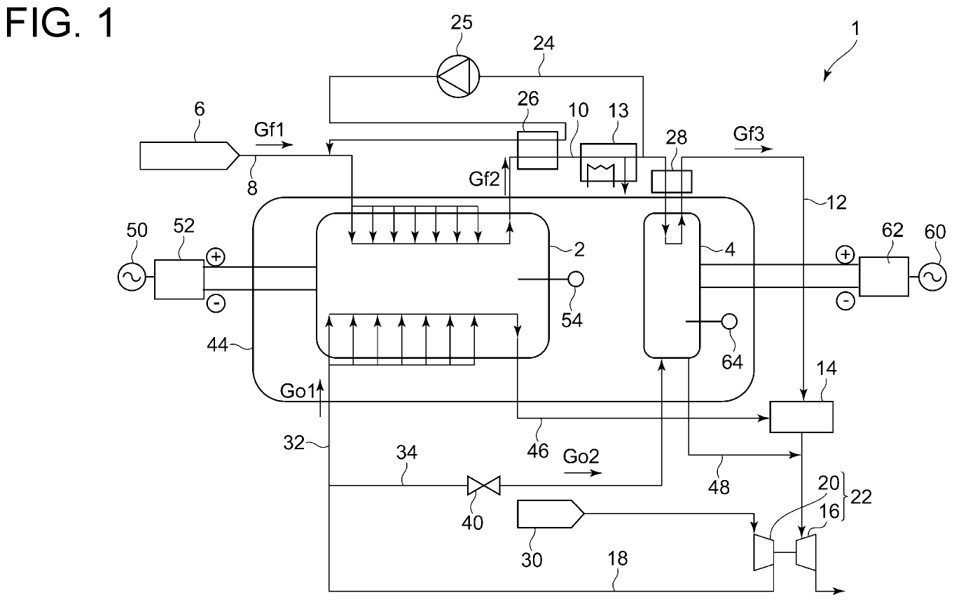

FIG. 1 is a schematic view showing an entire configuration of a fuel cell power generation system 1 according to a first embodiment. The fuel cell power generation system 1 includes a first fuel cell 2 and a second fuel cell 4. The first fuel cell 2 and the second fuel cell 4 are each a solid oxide fuel cell (SOFC) and generate power by causing electrochemical reaction using a fuel gas and an oxidant gas. The fuel gas is methane gas (natural gas) or propane gas, for example. The oxidant gas is air, for example.

The first fuel cell 2 includes a first inverter 52 for converting generated DC power to AC power responsive to a first power system 50. A temperature at the first fuel cell 2 (power generation chamber temperature) is monitored by a first temperature sensor 54 and can be controlled in such a manner that a detected value from the first temperature sensor 54 becomes a predetermined temperature by regulating a current amount in the first inverter 52.

The second fuel cell 4 includes a second inverter 62 for converting generated DC power to AC power responsive to a second power system 60. A current amount in the second inverter 62 is set to an appropriate value in response to the amount of a second fuel gas exhausted from the first fuel cell 2. A temperature at the second fuel cell 4 (power generation chamber temperature) is monitored by a second temperature sensor 64 and can be controlled using an oxidant gas flow rate in such a manner that a detected value from the second temperature sensor 64 becomes a predetermined temperature.

As described later in detail, if a detected value from the second temperature sensor 64 becomes equal to or less than a reference value, a supply amount of an oxidant gas to be supplied to the second fuel cell 4 is reduced using a regulating valve 40 to regulate a temperature at the second fuel cell 4 within a proper range.

A fuel gas (first fuel gas Gf1) is supplied from a fuel gas supply source 6 to the first fuel cell 2 through a first fuel gas supply line 8. The first fuel cell 2 includes a plurality of single cells (not shown in the drawings). The first fuel gas supply line 8 branches into the corresponding single cells to supply the fuel gas in parallel.

A fuel gas (second fuel gas Gf2) exhausted from each single cell of the first fuel cell 2 is supplied to the second fuel cell 4 through a second fuel gas supply line 10. The second fuel cell 4 includes at least one single cell (not shown in the drawings).

A fuel gas (third fuel gas Gf3) exhausted from the second fuel cell 4 is exhausted through a fuel gas exhaust line 12. The fuel gas exhaust line 12 is provided with a combustor 14 for causing combustion of the fuel gas and a turbine 16 capable of being driven using a combustion gas generated by the combustor 14. The combustor 14 may be a catalytic combustor. As described later, the turbine 16 is coupled to a compressor 20 provided in an oxidant gas supply line 18 and forms a turbocharger 22 together with the compressor 20.

A moisture collector 13 may be provided in the second fuel gas supply line 10. The moisture collector 13 is a device for collecting moisture in the fuel gas (second fuel gas Gf2) exhausted from the first fuel cell 2 and is configured as a condenser available for condensing and collecting moisture in the fuel gas (second fuel gas Gf2) through the second fuel gas supply line 10 by exchanging heat of the fuel gas (second fuel gas Gf2) with an external cooling medium, for example. By doing so, moisture in the fuel gas (second fuel gas Gf2) supplied to the second fuel cell 4 is reduced to increase a heat value of the fuel gas supplied to the second fuel cell 4. As a result, it becomes possible to improve power generation output from the second fuel cell 4.

A recirculation line 24 branches from a part of the second fuel gas supply line 10 downstream from the moisture collector 13. The recirculation line 24 is provided with a blower 25 configured in such a manner that driving the blower 25 causes part of the fuel gas (second fuel gas Gf2) flowing through the second fuel gas supply line 10 to recirculate toward an entrance of the first fuel cell 2. The recirculation line 24 is provided with a first regenerative heat exchanger 26 configured to allow temperature increase of the fuel gas passing through the recirculation line 24 by exchanging heat of this fuel gas with the fuel gas passing through the second fuel gas supply line 10.

A second regenerative heat exchanger 28 is provided in a part of the fuel gas exhaust line 12 upstream from the combustor 14. The second regenerative heat exchanger 28 is configured to allow temperature increase of the fuel gas (third fuel gas Gf3) exhausted from the second fuel cell 4 by changing heat of this fuel gas with the fuel gas (second fuel gas Gf2) flowing through the second fuel gas supply line 10. By doing so, the temperature of the fuel gas supplied to the combustor 14 is increased to allow a combustion temperature at the combustor 14.

The oxidant gas is supplied from an oxidant gas supply source 30 to the first fuel cell 2 and the second fuel cell 4 through the oxidant gas supply line 18. The oxidant gas supply line 18 is provided with the compressor 20 used for condensing and supplying the oxidant gas and forming the turbocharger 22 together with the above-described turbine 16.

A first oxidant gas supply line 32 and a second oxidant gas supply line 34 branch from a part of the oxidant gas supply line 18 downstream from the compressor 20. The first oxidant gas supply line 32 is connected to the first fuel cell 2 and the second oxidant gas supply line 34 is connected to the second fuel cell 4. By doing so, the first fuel cell 2 and the second fuel cell 4 are connected parallel to each other relative to the oxidant gas supply source 30.

At least one of the first oxidant gas supply line 32 and the second oxidant gas supply line 34 is provided with the regulating valve 40 for regulating a supply amount of the oxidant gas to be supplied to the second fuel cell 4. In the example of FIG. 1, the regulating valve 40 is provided in the second oxidant gas supply line 34 connected to the second fuel cell 4 and is configured to allow regulation of a supply amount of the oxidant gas (second oxidant gas Go2) to be supplied to the second fuel cell 4 by regulating a degree of opening of the regulating valve 40.

An initial degree of opening of the regulating valve 40 is set in such a manner as to realize a predetermined ratio relative to a supply amount of the oxidant gas (first oxidant gas Go1) to be supplied to the first fuel cell 2. As described later, this initial degree of opening is variably controlled in response to a detected value from the second temperature sensor 64.

As a variation of the present embodiment, a supply amount of the oxidant gas (second oxidant gas Go2) to be supplied to the second fuel cell 4 may be regulated indirectly by providing the regulating valve 40 in the first oxidant gas supply line 32 connected to the first fuel cell 2 and regulating a supply amount of the oxidant gas (first oxidant gas Go1) to be supplied to the first fuel cell 2. Alternatively, supply amounts of the oxidant gases (first oxidant gas Go1 and second oxidant gas Go2) to be supplied to the first fuel cell 2 and the second fuel cell 4 may be regulated finely by providing the regulating valve 40 in each of the first oxidant gas supply line 32 and the second oxidant gas supply line 34 and regulating a degree of opening of each of the regulating valves 40, while this causes a disadvantage in terms of cost.

Providing the regulating valve 40 in at least one of the first oxidant gas supply line 32 and the second oxidant gas supply line 34 in this way allows regulation of a supply ratio between the oxidant gases to be supplied to the first fuel cell 2 and the second fuel cell 4. By doing so, a configuration for regulating a supply amount of the oxidant gas (second oxidant gas Go2) to be supplied to the second fuel cell 4 in a subsequent stage can be realized in an efficient layout.

As described above, the second fuel cell 4 is provided with the second temperature sensor 64 for detecting a power generation chamber temperature at the second fuel cell 4. The regulating valve 40 is regulated in such a manner that a temperature at the second fuel cell 4 detected by the second temperature sensor 64 becomes a reference value set in advance. The reference value is defined as a temperature (for example, from 880 to 930 degrees) necessary for realizing a proper operating status of the second fuel cell 4. If a temperature at the second fuel cell 4 detected by the second temperature sensor 64 is less than the reference value, for example, a degree of opening of the regulating valve 40 is reduced to reduce a supply amount of the oxidant gas (second oxidant gas Go2) to be supplied to the second fuel cell 4. By doing so, at the second fuel cell 4, cooling performance provided using the oxidant gas (second oxidant gas Go2) is limited to increase a temperature corresponding to the suppression. As a result, a temperature at the second fuel cell 4 in the subsequent stage is properly maintained at the reference value to realize a high-efficiency fuel cell power generation system.

A degree of opening of the regulating valve 40 may be controlled manually by an operator on the basis of a detected value from the second temperature sensor 64. A layout of the present embodiment is such that, while the first fuel cell 2 and the second fuel cell 4 are housed in a pressure vessel 44, the regulating valve 40 is arranged outside the pressure vessel 44. This allows the operator to access the regulating valve 40 easily and to operate the regulating valve 40 easily.

Control over a degree of opening of the regulating valve 40 based on a detected value from the second temperature sensor 64 may be performed as automatic control using an electronic computing unit such as a computer, for example. In this case, the regulating valve 40 is controlled automatically by inputting a detected value from the second temperature sensor 64 as an electrical signal to a controller and outputting a control signal responsive to a degree of opening corresponding to the detected value from the second temperature sensor 64 to the regulating valve 40.

The oxidant gas exhausted from the first fuel cell 2 is supplied to the combustor 14 through a first oxidant gas exhaust line 46. At the combustor 14, the oxidant gas exhausted from the first oxidant gas exhaust line and the third fuel gas Gf3 supplied from the fuel gas exhaust line 12 are mixed with each other to cause combustion.

The oxidant gas exhausted from the second fuel cell 4 is supplied to a part downstream from the combustor 14 through a second oxidant gas exhaust line 48. Specifically, the second oxidant gas exhaust line 48 is configured to supply the oxidant gas exhausted from the second fuel cell 4 to the turbine 16 without intervention of the combustor 14 by being connected between the combustor 14 and the turbine 16 in such a manner as to bypass the combustor 14. This makes it possible to avoid increase in pressure loss occurring in the presence of intervention of the combustor 14, thereby allowing suppression of collecting power reduction at the turbocharger 22.

If permissible pressure loss at the second oxidant gas exhaust line 48 is sufficiently large, the second oxidant gas exhaust line 48 may be connected to the combustor 14 like the first oxidant gas exhaust line 46.

### Second Embodiment

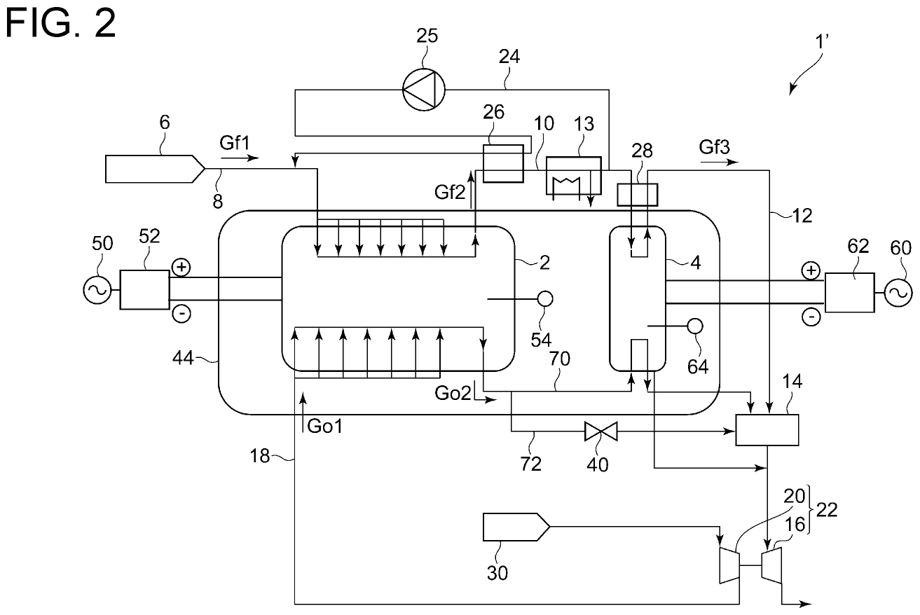

FIG. 2 is a schematic view showing an entire configuration of a fuel cell power generation system 1′ according to a second embodiment. A structure of the fuel cell power generation system 1′ corresponding to the structure described in the foregoing embodiment is given a common sign and description overlapping between such structures will be omitted, if appropriate.

In the second embodiment, while the fuel gas is supplied to the first fuel cell 2 and the second fuel cell 4 using the same supply system as that of the above-described first embodiment, the oxidant gas is supplied using a different supply system. More specifically, the oxidant gas (first oxidant gas Go1) supplied from the compressor 20 is first guided to the first fuel cell 2 through the oxidant gas supply line 18 (in the second embodiment, unlike in the first embodiment, the oxidant gas supply line 18 does not branch into the first oxidant gas supply line 32 and the second oxidant to the second oxidant gas supply line 34 but is connected only to the first fuel cell 2).

The oxidant gas (first oxidant gas Go1) supplied to the first fuel cell 2 is used for power generation at the first fuel cell 2, and is then exhausted as the second oxidant gas Go2 from the first fuel cell 2. The oxidant gas (second oxidant gas Go2) exhausted from the first fuel cell 2 is supplied to the second fuel cell 4 through a third oxidant gas supply line 70 provided between the first fuel cell 2 and the second fuel cell 4. In this way, the oxidant gas having been used at the first fuel cell 2 is fed to the second fuel cell 4 in the subsequent stage through the third oxidant gas supply line 70.

The third oxidant gas supply line 70 includes a fourth oxidant gas supply line 72 provided in such a manner as to branch from the third oxidant gas supply line 70 and to bypass the second fuel cell 4. The regulating valve 40 is provided in at least one of the third oxidant gas supply line 70 and the fourth oxidant gas supply line 72. In the example of FIG. 2, the regulating valve 40 is provided in the fourth oxidant gas supply line 72 and is configured to allow regulation of a supply amount of the oxidant gas to be supplied to the second fuel cell 4 by regulating a degree of opening of the regulating valve 40 to regulate a flow rate of the oxidant gas in the fourth oxidant gas supply line 72.

An initial degree of opening of the regulating valve 40 is set in such a manner as to realize a predetermined ratio of a supply amount of the oxidant gas (second oxidant gas Go2) to be supplied to the second fuel cell 4 relative to a supply amount of the oxidant gas (first oxidant gas Go1) to be supplied to the first fuel cell 2. As described later, this initial degree of opening is variably controlled in response to a detected value from the second temperature sensor 64.

As a variation of the present embodiment, a supply amount of the oxidant gas to be supplied to the second fuel cell 4 may be regulated directly by providing the regulating valve 40 in the third oxidant gas supply line 70. Alternatively, supply amounts of the oxidant gases to be supplied to the first fuel cell 2 and the second fuel cell 4 may be regulated finely by providing the regulating valve 40 in each of the third oxidant gas supply line 70 and the fourth oxidant gas supply line 72 and regulating a degree of opening of each of the regulating valves 40, while this causes a disadvantage in terms of cost.

Providing the regulating valve 40 in at least one of the third oxidant gas supply line 70 and the fourth oxidant gas supply line 72 in this way allows regulation of a supply ratio between the oxidant gases to be supplied to the first fuel cell 2 and the second fuel cell 4.

By doing so, a configuration for regulating a supply amount of the oxidant gas to be supplied to the second fuel cell 4 in the subsequent stage can be realized in an efficient layout.

The fourth oxidant gas supply line 72 is configured in such a manner that, by connecting a downstream part of the fourth oxidant gas supply line 72 to the combustor 14, the oxidant gas having passed through the fourth oxidant gas supply line 72 causes combustion at the combustor 14 together with a combustion gas (third fuel gas Gf3) having passed through the fuel gas exhaust line 12. This configuration may be replaced with a configuration like that of FIG. 1 in which the downstream part of the fourth oxidant gas supply line 72 is connected between the combustor 14 and the turbine 16 to reduce pressure loss occurring by the combustor 14.

### Third Embodiment

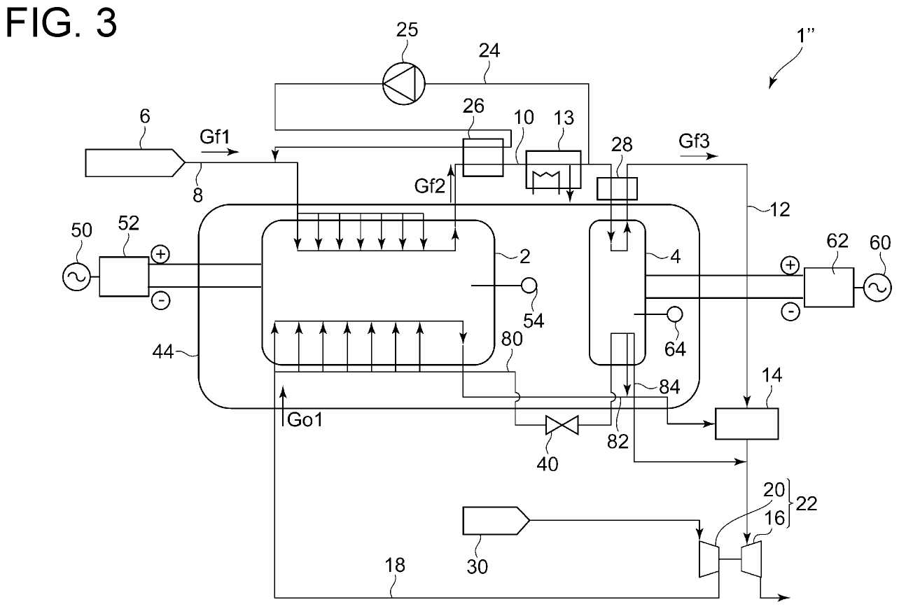

FIG. 3 is a schematic view showing an entire configuration of a fuel cell power generation system 1″ according to a third embodiment. A structure of the fuel cell power generation system 1″ corresponding to the structure described in the foregoing embodiments is given a common sign and description overlapping between such structures will be omitted, if appropriate.

In the third embodiment, while the fuel gas is supplied to the first fuel cell 2 and the second fuel cell 4 using the same supply system as that of the above-described first embodiment, the oxidant gas is supplied from the first fuel cell 2 and the second fuel cell 4 using a different supply system.

In the present embodiment, the oxidant gas is supplied to all the single cells of the first fuel cell 2 from the oxidant gas supply source 30 through the oxidant gas supply line 18. A fifth oxidant gas supply line 80 is derived toward the second fuel cell 4 in such a manner as to take out some of the branches from the oxidant gas supply line 18 to the respective single cells, thereby realizing a configuration in which the oxidant gas supplied to the first fuel cell 2 is partially supplied to the second fuel cell 4.

The oxidant gas having been used at the first fuel cell 2 is exhausted to the combustor 14 through a third oxidant gas exhaust line 82. The oxidant gas having been used at the second fuel cell 4 is exhausted through a fourth oxidant gas exhaust line 84. The fourth oxidant gas exhaust line 84 is merged at a downstream position with the third oxidant gas exhaust line 82. By doing so, the oxidant gases exhausted from corresponding ones of the first fuel cell 2 and the second fuel cell 4 are supplied to the combustor 14 to cause combustion together with the fuel gas (third fuel gas Gf3) exhausted from the fuel gas exhaust line 12.

### Fourth Embodiment

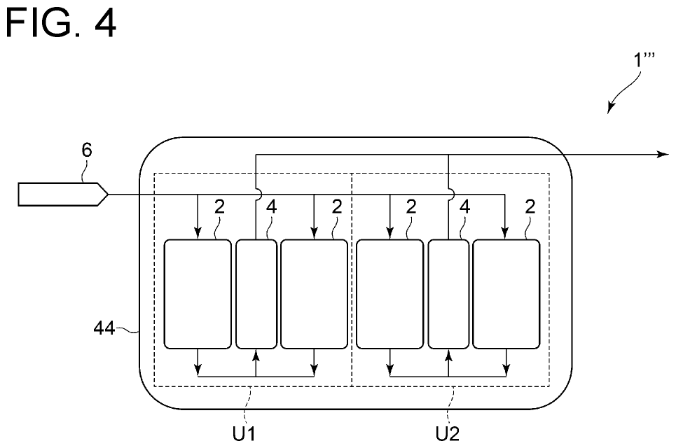

FIG. 4 is a schematic view showing an entire configuration of a fuel cell power generation system 1′″ according to a fourth embodiment. A structure of the fuel cell power generation system 1′″ corresponding to the structure described in the foregoing embodiments is given a common sign and description overlapping between such structures will be omitted, if appropriate.

The fuel cell power generation system 1′″ includes at least one fuel cell unit with the first fuel cell 2 and the second fuel cell 4 corresponding to each of the foregoing embodiments. The fuel cell power generation system 1′″ shown in FIG. 4 includes a first fuel cell unit U1 and a second fuel cell unit U2.

While a supply system for the fuel gas is schematically shown in FIG. 4, it has the same configuration as that of the foregoing embodiments. While a supply system for the oxidant gas is omitted from FIG. 4, it has the same configuration as that of the foregoing embodiments or may have a configuration resulting from combination of the configurations of the corresponding embodiments.

Each fuel cell unit of the fuel cell power generation system 1′″ is configured in such a manner that the second fuel cell 4 is arranged between the two first fuel cells 2. As described above, the second fuel cell 4 is arranged in a subsequent stage to the first fuel cell 2 and reuses the fuel gas of a low heat value having been used at the first fuel cell 2. Thus, arranging the second fuel cell 4 to handle the fuel gas of a low heat value between the first fuel cells 2 makes it possible to suppress temperature drop at the second fuel cell 4 more effectively.

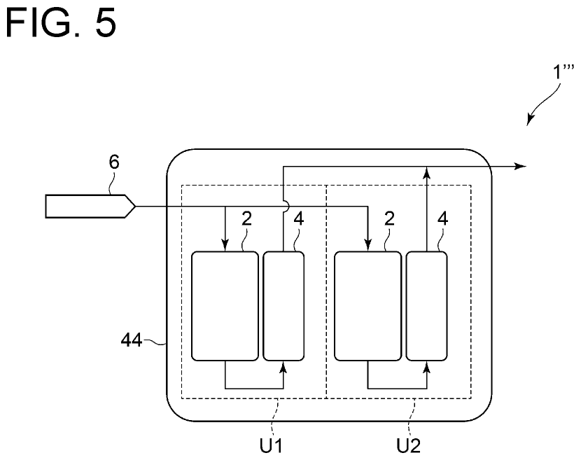

FIG. 5 is a modification of FIG. 4. According to this modification, each fuel cell unit includes one first fuel cell 2 and one second fuel cell 4. With a plurality of fuel cell units aligned in a predetermined direction, the first fuel cell 2 and the second fuel cell 4 are arranged alternately to locate the second fuel cell 4 to handle the fuel gas of a low heat value between the first fuel cells 2 of corresponding fuel cell units adjacent to each other. Like in the case of FIG. 4, this configuration makes it possible to suppress temperature drop at the second fuel cell 4 more effectively.

As described above, according to each of the foregoing embodiments, it is possible to provide a fuel cell power generation system with a cascade connection of a plurality of solid oxide fuel cells capable of suppressing reduction in power generation performance and realizing excellent system efficiency by maintaining a temperature at a solid oxide fuel cell in a subsequent stage properly.

### INDUSTRIAL APPLICABILITY

At least one embodiment of the present invention is applicable to a fuel cell power generation system generating power using a plurality of fuel cells.

### REFERENCE SIGNS LIST

1 Fuel cell power generation system
2 First fuel cell
4 Second fuel cell
6 Fuel gas supply source
8 First fuel gas supply line
10 Second fuel gas supply line
12 Fuel gas exhaust line
13 Moisture collector
14 Combustor
16 Turbine
18 Oxidant gas supply line
20 Compressor
22 Turbocharger
24 Recirculation line
25 Blower
26 First regenerative heat exchanger
28 Second regenerative heat exchanger
30 Oxidant gas supply source
32 First oxidant gas supply line
34 Second oxidant gas supply line
40 Regulating valve
44 Pressure vessel
46 First oxidant gas exhaust line
48 Second oxidant gas exhaust line
50 First power system
52 First inverter
54 First temperature sensor
60 Second power system
62 Second inverter
64 Second temperature sensor
70 Third oxidant gas supply line
72 Fourth oxidant gas supply line
80 Fifth oxidant gas supply line
82 Third oxidant gas exhaust line
84 Fourth oxidant gas exhaust line

1. A fuel cell power generation system comprising:
a first fuel cell generating power using a first fuel gas and a first oxidant gas;
a second fuel cell generating power using a second fuel gas exhausted from the first fuel cell and a second oxidant gas supplied from at least one of an oxidant gas supply source and the first fuel cell; and
a regulating valve configured to regulate a supply amount of the second oxidant gas to be supplied to the second fuel cell,
the regulating valve being regulated in such a manner that a temperature at the second fuel cell becomes a reference value.

2. The fuel cell power generation system according to claim 1, wherein
the first oxidant gas and the second oxidant gas are supplied to the first fuel cell and the second fuel cell through a first oxidant gas supply line and a second oxidant gas supply line respectively arranged parallel to each other relative to the oxidant gas supply source common to the first oxidant gas and the second oxidant gas, and
the regulating valve is arranged in at least one of the first oxidant gas supply line and the second oxidant gas supply line.

3. The fuel cell power generation system according to claim 1, comprising:
a third oxidant gas supply line arranged between the first fuel cell and the second fuel cell in such a manner that the first oxidant gas is supplied as the second oxidant gas to the second fuel cell after being exhausted from the first fuel cell; and
a fourth oxidant gas supply line branching from the third oxidant gas supply line in such a manner as to bypass the second fuel cell, wherein
the regulating valve is arranged in at least one of the third oxidant gas supply line and the fourth oxidant gas supply line.

4. The fuel cell power generation system according to claim 1, comprising:
a combustor causing combustion of a third fuel gas exhausted from the second fuel cell;
a turbine arranged downstream from the combustor; and
a compressor driven by the turbine, wherein
the second oxidant gas is supplied to the turbine without intervention of the combustor after being exhausted from the second fuel cell.

5. The fuel cell power generation system according to claim 4, wherein
the first oxidant gas is supplied to the combustor after being exhausted from the first fuel cell.

6. The fuel cell power generation system according to claim 1, comprising:
a combustor causing combustion of a third fuel gas exhausted from the second fuel cell;
a turbine arranged downstream from the combustor; and
a compressor driven by the turbine, wherein
the first oxidant gas and the second oxidant gas are supplied to the combustor after being exhausted from the first fuel cell and the second fuel cell respectively.

7. The fuel cell power generation system according to claim 1, further comprising:
a pressure vessel housing the first fuel cell and the second fuel cell, wherein
the regulating valve is arranged outside the pressure vessel.

8. The fuel cell power generation system according to claim 1, comprising:
a moisture collector collecting moisture in the second fuel gas; and
a recirculation line causing part of the second fuel gas to recirculate into the first fuel cell after the moisture is collected by the moisture collector.

9. The fuel cell power generation system according to claim 1, comprising at least one fuel cell unit in which the second fuel cell is arranged between a plurality of the first fuel cells.
